(19) United States
(12) Patent Application Publication
(10) Pub. No.: US 2005/0185795 A1
(43) Pub. Date: Aug. 25, 2005

(54) Apparatus and/or method for adaptively encoding and/or decoding scalable-encoded bitstream, and recording medium including computer readable code implementing the same

(75) Inventors: Byung-cheol Song, Gyeonggi-do (KR); Yang-lim Chol, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/036,321

(22) Filed: Jan. 18, 2005

(30) Foreign Application Priority Data
Jan. 19, 2004 (KR) 10-2004-0003808

(51) Int. Cl. H04N 7/167

(52) U.S. Cl. 380/218

(57) ABSTRACT

An encoding and decoding method for adaptively protecting a scalable-encoded bitstream. Accordingly, it is possible to adaptively protect a scalable-encoded bitstream by selectively encrypting a bitstream for a particular layer or embedding a watermark into the bitstream. The method is applicable to various fields of application.

### CROSS-REFERENCE TO RELATED APPLICATIONS

This application claims the benefit of Korean Patent Application No. 2004-3808 filed on Jan. 19, 2004 in the Korean Intellectual Property Office, the disclosure of which is incorporated herein in its entirety by reference.

### BACKGROUND OF THE INVENTION

1. Field of the Invention

The present invention relates to a method of adaptively protecting scalable-encoded bitstreams, and more particularly, to an encoding and decoding method for more adaptively protecting scalable-encoded bitstreams by selectively encrypting the bitstreams or inserting a watermark into the bitstreams.

2. Description of the Related Art

In general, although there are various copy protection methods based on the corresponding varying types of standards, copy protection is performed using a Data Encryption Standard (DES) method.

FIG. 1 is a flowchart illustrating a conventional method of protecting bitstreams encoded using a single layer, according to the DES method. The conventional method of FIG. 1 encrypts only I-frames of bitstreams, such as a Packetized Elementary Stream (PES), a Transport Stream (TS), and a Program Stream (PS), using the DES method, according to the Moving Picture Experts Group (MPEG) standard.

More specifically, it is determined whether an input bitstream that is a PES, a TS, or a PS corresponds to an I-frame, in operation 120. If it is then determined, in operation 120, that the input bitstream is the I-frame, the I-frame is encrypted, in operation 140, and a result of encryption is output, in operation 160.

However, in operation 120, if the input bitstream is not the I-frame, the input bitstream is directly output without being encrypted, in operation 160.

Although only a bitstream for the I-frame is encrypted, without encrypting a bitstream for a B-frame or a P-frame preceding the I-frame, it is impossible to reconstruct the B-frame or P-frame that refers to the I-frame without decrypting the I-frame. Accordingly, it is possible to draw the same result as obtained when encrypting the related whole Group-Of-Picture (GOP) by encrypting only the bitstream for the I-frame.

A method of encrypting and decrypting a bitstream, which is encoded with a single layer, using an encryption key is disclosed in WO 01/11890.

However, since a conventional method of protecting data from unauthorized users is applicable only to a bitstream encoded using a single layer, this method is improper for effectively protecting bitstreams available for various applications.

### SUMMARY OF THE INVENTION

Embodiments of the present invention provide a method, medium, and apparatus for encoding and decoding data capable of adaptively protecting a scalable-encoded bitstream by selectively encrypting a bitstream for a particular layer or embedding a watermark therein.

Additional aspects and/or advantages of the invention will be set forth in part in the description which follows and, in part, will be obvious from the description, or may be learned by practice of the invention.

According to an aspect of the present invention, there is provided a method of adaptively encoding a bitstream using scalable encoding, the method including scalable-encoding the bitstream using a predetermined scalable encoding method and selecting at least one layer of the scalable-encoded bitstream, and encrypting a bitstream corresponding to the at least one selected layer using a predetermined encryption key.

According to another aspect of the present invention, there is provided a recording medium for storing a computer readable code that executes a method of adaptively encoding a bitstream, wherein the method includes scalable-encoding the bitstream using a predetermined scalable encoding method and selecting at least one layer of the scalable-encoded bitstream, and encrypting a bitstream corresponding to the at least one selected layer using a predetermined encryption key.

According to yet another aspect of the present invention, there is provided a method of decoding a scalable-encoded bitstream, the method including demultiplexing the scalable-encoded bitstream to extract an unencrypted bitstream and an encrypted bitstream, decoding the extracted unencrypted bitstream, decrypting the encrypted bitstream using a predetermined encryption key, and reproducing the input bitstream using the decoded bitstream and the decrypted bitstream.

According to still another aspect of the present invention, there is provided a recording medium for storing a program that executes a method of adaptively decoding a bitstream, wherein the method includes demultiplexing the input scalable-encoded bitstream to extract an unencrypted bitstream and an encrypted bitstream, decoding the extracted unencrypted bitstream, decrypting the encrypted bitstream using a predetermined encryption key, and reproducing the input bitstream using the decoded bitstream and the bitstream decrypted by the predetermined encryption key.

According to still another aspect of the present invention, there is provided a method of adaptively encoding a bitstream using a scalable encoding method, the method including scalable-encoding the bitstream using a predetermined scalable encoding method and selecting at least one layer of the scalable-encoded bitstream, and embedding a watermark into a bitstream corresponding to the at least one selected layer.

According to still another aspect of the present invention, there is provided a recording medium for storing a program that executes a method of adaptively encoding a bitstream, wherein the method includes scalable-encoding the bitstream using a predetermined scalable encoding method and selecting at least one layer of the scalable-encoded bitstream, and embedding a watermark into a bitstream corresponding to the at least one selected layer using a predetermined encryption key.

According to still another aspect of the present invention, there is provided a method of adaptively decoding a scalable-encoded bitstream, the method including demultiplexing the scalable-encoded bitstream to extract a bitstream into a watermark is not embedded and a bitstream into which a watermark is embedded, encoding the bitstream into which the watermark is not embedded, removing the watermark from the bitstream into the watermark is embedded, and reproducing the input bitstream using the decoded bitstream and the bitstream from which the watermark is removed.

According to another aspect of the present invention, there is provided a recording medium for storing a program that executes a method of adaptively decoding a bitstream, wherein the method includes demultiplexing the input scalable-encoded bitstream to extract a bitstream into which a watermark is not embedded and a bitstream into which a watermark is embedded, decoding the extracted bitstream into which the watermark is not embedded, removing the watermark from the bitstream into which the watermark is embedded, and reproducing the input bitstream using the decoded bitstream and the bitstream from which the watermark is removed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a conventional method of protecting bitstreams encoded using a single layer;

FIG. 2 is a block diagram of an apparatus for encrypting scalable-encoded bitstreams, according to an embodiment of the present invention;

FIG. 3 is a block diagram of a Fine Granularity Scalability (FGS) encoding unit, as an example of the scalable encoder of FIG. 2, according to an embodiment of the present invention;

FIG. 4 is a diagram illustrating a method for partially encrypting an FGS bitstream encoded by the FGS scalable encoding unit of FIG. 3, according to an embodiment of the present invention;

FIG. 5 is a block diagram of an apparatus for decoding scalable-encoded bitstreams, according to an embodiment of the present invention;

FIG. 6 is a block diagram of an FGS encoding apparatus, according to an embodiment of the present invention;

FIG. 7 is a block diagram of a Signal-to-Noise Ratio (SNR) scalable encoding apparatus, according to an embodiment of the present invention;

FIGS. 8A and 8B are diagrams illustrating a method of encrypting wavelet-based scalable encoded bitstreams, according to an embodiment of the present invention;

FIG. 9 is a block diagram of a scalable encoding apparatus using watermarking, according to an embodiment of the present invention;

FIG. 10 illustrates a watermark-embedded image, according to an embodiment of the present invention;

FIG. 11 is a block diagram of an apparatus for embedding a watermark into a scalable encoded bitstream, according to an embodiment of the present invention; and

FIG. 12 is a block diagram of an apparatus for decoding scalable-encoded bitstreams, according to another embodiment of the present invention.

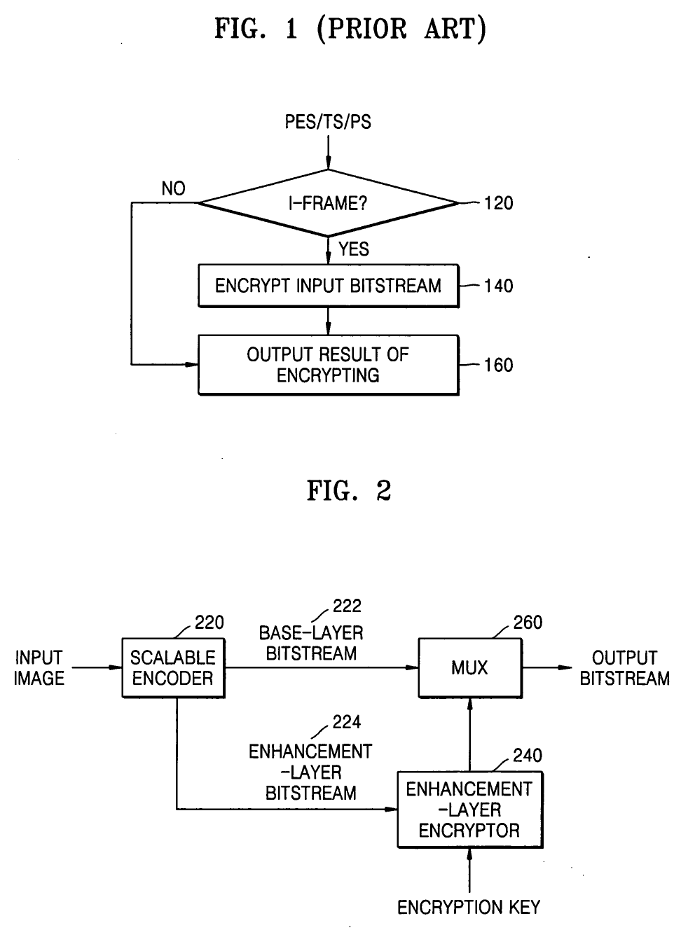

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout. The embodiments are described below to explain the present invention by referring to the figures.

FIG. 2 is a block diagram of an apparatus for encrypting a scalable-encoded bitstream, according to an embodiment of the present invention. The apparatus of FIG. 2 includes a scalable encoder 220, an enhancement-layer bitstream encryptor 240, and a multiplexer 260.

The scalable encoder 220 generates a base-layer bitstream 222 and an enhancement-layer bitstream 224 according to a predetermined scalable encoding method, and outputs the base-layer bitstream 222 and the enhancement-layer bitstream 224 to the multiplexer 260 and the enhancement-layer bitstream encryptor 240, respectively.

Here, the base-layer bitstream 222 can be decoded independently from other bitstreams and the enhancement-layer bitstream 224 is used to improve the base-layer bitstream.

There are various types of scalable encoding methods such as a spatial scalable encoding method, a temporal scalable-encoding method, a Signal-to-Noise Ratio (SNR) scalable encoding method, and a Fine Granularity Scalability (FGS) encoding method, for example.

In detail, in the spatial scalable encoding method, a base-layer bit stream is a bitstream with low resolution or a small-sized bitstream, and an enhancement-layer bitstream is used to increase the resolution or size of the base-layer bitstream. When the spatial scalable encoding method is adopted by television (TV) broadcast, the base-layer bitstream is generated such that it can be reproduced by both the existing TV receiver and a high-definition TV receiver, and the enhancement-layer bitstream is generated so that it can be reproduced only by the HDTV receiver. It is possible to make a bitstream that is compatible both with the existing TV receiver and the HDTV receiver by multiplexing these bitstreams.

The temporal scalable encoding method allows temporal resolution of a bitstream to be selectively improved. For instance, when a base-layer bitstream has a resolution with 30 frames per second, it is possible to increase the resolution of the base-layer bitstream to a resolution with 60 frames per second using an enhancement-layer bitstream.

The SNR scalable encoding method allows the quality of a reproduced image to be selectively improved. For instance, when base-layer bitstreams contain a bitstream that will be reproduced as a low-quality image, it is possible to obtain a high-quality image by decoding the base-layer bitstreams and decoding an enhancement-layer bitstream based on a result of decoding.

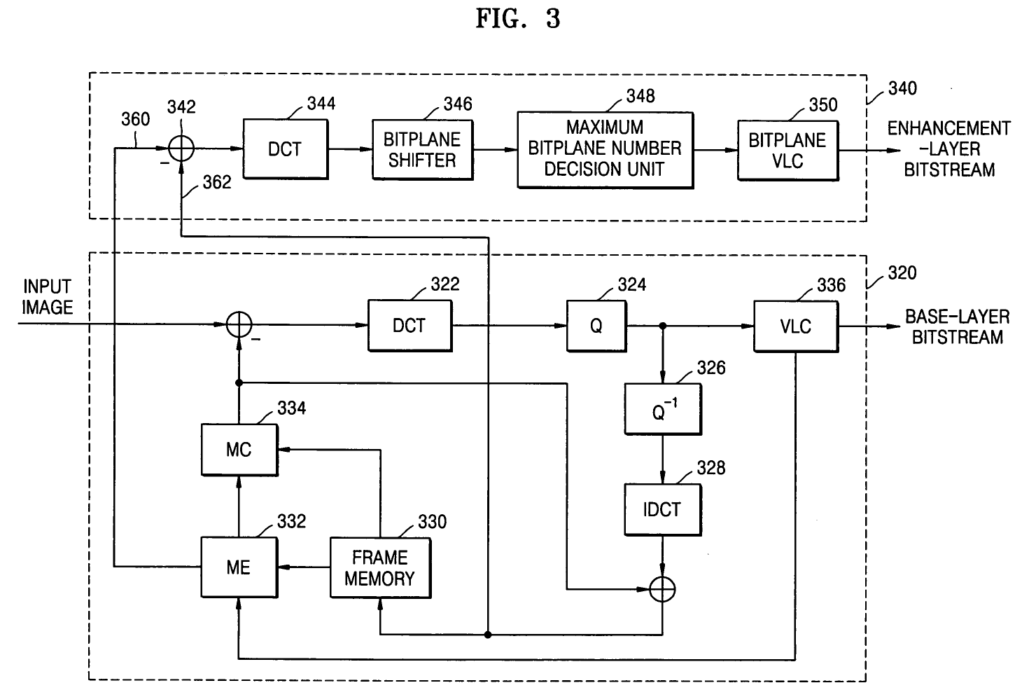

The FGS scalability encoding method guarantees scalability with more layers. There is a case where a transmitting side transmits a base-layer bitstream that contains information of an image with a base quality and a minimum bandwidth permitted under a transmission environment, and an enhancement-layer bitstream that contains information of an improved image with a maximum bandwidth, under a rapidly changing transmission environment, and a receiving side receives the base-layer bitstream but does not receive the enhancement-layer bitstream. In this case, the FGS scalability encoding method allows the information of the improved image to be reconstructed using all bitstreams received by the receiving side. The FGS scalability encoding method will be described in detail with reference to FIG. 3.

As illustrated in FIG. 2, the enhancement-layer bitstream encryptor 240 encrypts the input enhancement-layer bitstream using a predetermined encryption key and a predetermined encrypting method such as a Data Encryption Standard (DES) method, and outputs a result of the encrypting to the multiplexer 260.

The multiplexer 260 multiplexes the base-layer bitstream input from the scalable encoder 220 and the enhancement-layer bitstream encrypted by the enhancement-layer bitstream encryptor 240, and outputs a result of the multiplexing.

FIG. 3 is a block diagram of an FGS encoding unit, which is an example of the scalable encoder 220 of FIG. 2, based on a Discrete Cosine Transform (DCT)-bitplane. The FGS encoding unit of FIG. 3 includes a base-layer bitstream generating unit 320 and an enhancement-layer bitstream generating unit 340. The base-layer bitstream generating unit 320 may include a DCT unit 322, a quantizer 324, an inverse quantizer 326, an inverse DCT (IDCT) unit 328, a frame memory 330, a motion estimator 332, a motion compensator 334, and a variable-length coder (VLC) 336. The enhancement-layer bitstream generating unit 340 includes a subtracter 342, a DCT unit 344, a bitplane shifter 346, a maximum bitplane number decision unit 348, and a bitplane VLC 350.

The base-layer bitstream generating unit 320 will now be more specifically described with reference to FIG. 3. First, the DCT unit 322 performs DCT on input image data 360 on a basis of 8×8 pixel block units to remove spatial correlation existing among adjacent pixels. The quantizer 324 quantizes a DCT coefficient obtained from the DCT unit 322 to express it with several representative values, thus enabling high-efficiency lossy compression.

The inverse quantizer 326 inversely quantizes the image data quantized by the quantizer 324. The IDCT unit 328 performs IDCT on the image data that is inversely quantized by the inverse quantizer 326. The frame memory 330 stores the image data on which IDCT is performed by the IDCT unit 328 in units of frames.

The motion estimator 332 and the motion compensator 334 estimate a motion vector and a sum-of-absolute differences (SAD) that is a block matching error of each macro block, using input image data corresponding to a current frame and image data that corresponds to a previous frame and is stored in the frame memory 330.

The VLC 336 removes the statistical redundancy in the quantized image data on which DCT is performed.

The enhancement-layer bitstream generating unit 340 will now be more specifically described with reference to FIG. 3. The subtracter 342 computes residues in units of pixels by calculating the difference between the input image data 360 and estimated image data 362 output from the base-layer bitstream generating unit 320.

The DCT unit 344 divides the respective residues obtained by the subtracter 342 in units of 8×8 DCT blocks and performs DCT on the 8×8 blocks to obtain 8×8 DCT blocks.

The bitplane shifter 346 selectively shifts the residues on which DCT is performed in units of bitplanes, according to the importance of the input 8×8 DCT blocks. For instance, when a DCT bitplane for a DCT block is defined with f1 bit of data to 8 bits of data, a DCT bitplane for an important DCT block is shifted with from 3 bits of data to 8 bits of data.

The maximum bitplane number decision unit 348 determines a maximum bitplane number of an input bitstream in units of DCT blocks.

The bitplane VCL 350 variable-length codes the respective bitplanes to generate and output enhancement-layer bitstreams.

As described above, in an FGS encoding method, the base-layer bitstream 222 is encoded; the residue between the input image data 360 and the estimated image data 362 obtained by encoding the base-layer bitstreams 222 is divided by the respective bitplanes; variable-length coding is performed on the bitplanes in the sequence from a bitplane that contains a most significant bit (MSB) to a bitplane that contains a least significant bit (LSB), i.e., from the MSB stream, an MSB-1 stream, an MSB-2 stream, . . . , the LSB stream; and results of variable-length coding are sequentially transmitted.

For instance, when a pixel, whose residue between the original image data and estimated image data is 10, has four bitplanes (1, 0, 1, 0), the bitplanes (1, 0, 1, 0) are sequentially transmitted starting from the most significant bit of 1 of the four bitplanes (1, 0, 1, 0).

A decoding side receives the base-layer bitstream transmitted at a minimum transmission bandwidth guaranteed by a transmission line, decodes the base-layer bitstream to generate an estimated image, and sequentially decodes enhancement-layer bitstreams to obtain the original image. For instance, if a pixel whose residue is 10 includes the MSB bitplane, the residue of 10 (1010) is decoded to a residue of 8 (1000).

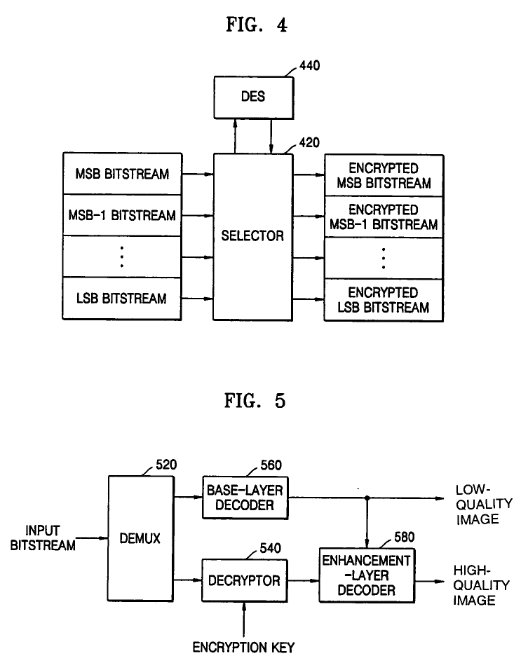

FIG. 4 is a diagram illustrating a method of partially encrypting an FGS bitstream encoded by the FGS scalable encoding unit of FIG. 3, according to an embodiment of the present invention. Referring to FIG. 4, a selector 420 selects at least one of the bitstreams, i.e., the MSB stream, the MSB-1 stream, the MSB-2 stream, . . . , the LSB stream, which are output from the enhancement-layer bitstream generating unit 340 of FIG. 3, outputs the selected bitstream to an encryptor 440, and directly transmits the remaining bitstreams.

The encryptor 440, which corresponds to the enhancement-layer encryptor 240 of FIG. 2, encrypts the selected bitstream using a predetermined encrypting method such as the DES method and outputs the encrypted bitstream to the selector 420. Then, the selector 420 outputs the encrypted bitstream.

Accordingly, even when an apparatus, such as a decrypting apparatus that receives bitstreams, does not have a decrypting key, at least parts of a reconstructed image can be recognized since only partial bitstreams of enhancement-layer bitstreams are selectively encrypted. Thus, the method of FIG. 4 allows a user to identify at least part of the contents being transmitted, and thus is applicable to various fields of application.

FIG. 5 is a block diagram of an apparatus for decoding a bitstream that is scalable-encoded and encrypted, according to an embodiment of the present invention. The apparatus of FIG. 5 includes a demultiplexer 520, a decryptor 540, a base-layer decoder 560, and an enhancement-layer decoder 580.

The demultiplexer 520 separates a base-layer bitstream and an enhancement-layer bitstream from input bit streams and outputs the base-layer bitstream and the enhancement-layer bitstream to the base-layer decryptor 560 and the decryptor 540, respectively.

The base-layer decoder 560 decodes the input base-layer bitstream to obtain an image. The image output from the base-layer decoder 560 is a low-quality image that can be independently displayed.

The decryptor 540 decrypts the input enhancement-layer bitstream using an encryption key used to encrypt the enhancement-layer bitstream and outputs a result of decryption to the enhancement-layer decoder 580.

The enhancement-layer decoder 580 reconstructs a high-quality image using the base-layer bitstream decoded by the base-layer decoder 560 and the enhancement-layer bitstream decrypted by the decryptor 540, and outputs the high-quality image.

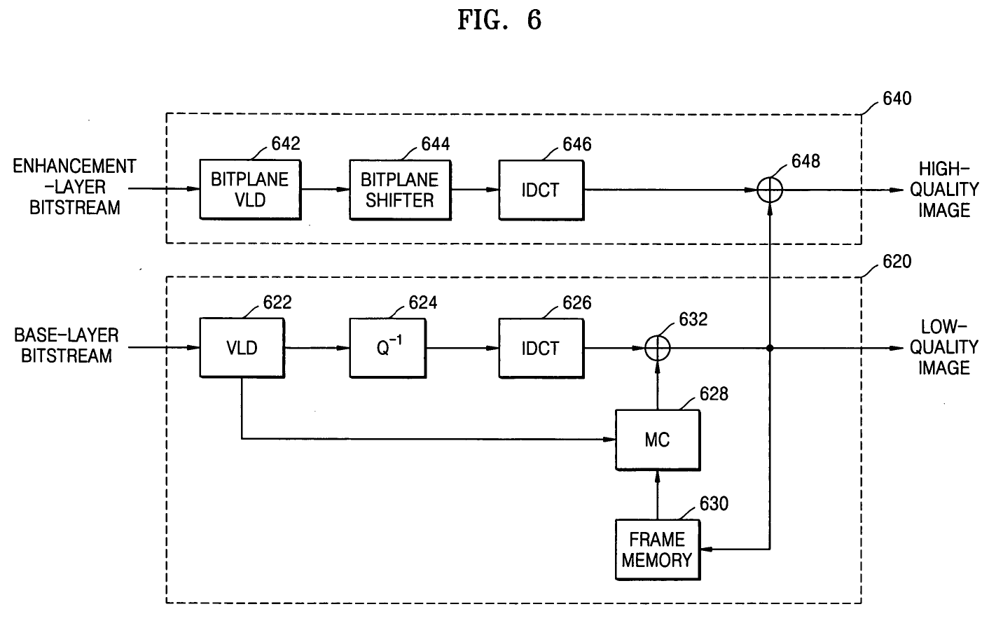

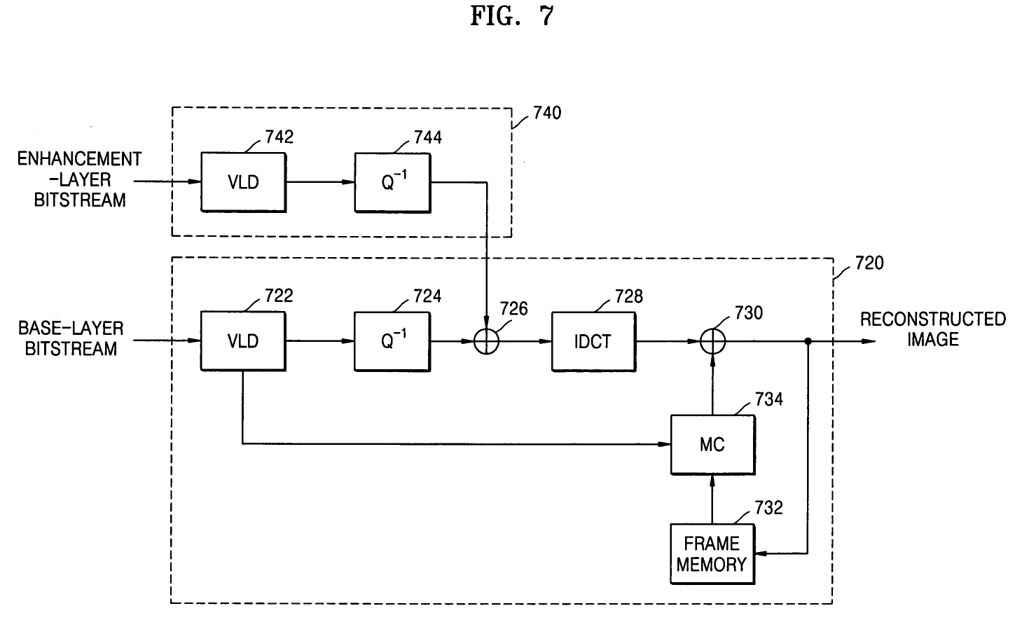

The base-layer decoder 560 and the enhancement-layer decoder 580 will now be described in detail with reference to FIGS. 6 and 7.

FIG. 6 is a block diagram of an FGS scalable decoding apparatus that corresponds to the base-layer decoder 560 and the enhancement-layer decoder 580 of FIG. 5. The apparatus of FIG. 6 includes a base-layer decoding unit 720 and an enhancement-layer decoding unit 640. The base-layer decoding unit 620 includes a variable-length decoder (VLD) 622, an inverse quantizer 624, an IDCT unit 626, a motion compensator 628, a frame memory 630, and an adder 632. The enhancement-layer decoding unit 640 includes a bitplane VLD 642, a bitplane shifter 644, an IDCT unit 646, and an adder 648.

A base-layer bitstream input to the base-layer decoding unit 620 is variable-length decoded by the VLD 622. During the variable-length decoding, information regarding the type of current picture and information regarding whether motion estimation is performed are also obtained. Next, the variable-length decoded bitstream is inversely quantized by the inverse quantizer 624 and the IDCT unit 626 performs IDCT on a result of inverse quantization. If the input bitstream corresponds to a P-picture or a B-picture, the motion compensator 628 performs motion compensation on a reference frame stored in the frame memory 630. Next, the adder 632 combines a result of motion compensation and the bitstream on which IDCT is performed by the IDCT unit 626 and outputs a result of the addition as an output image.

An enhancement-layer bitstream input to the enhancement-layer decoding unit 640 is variable-length decoded in a DCT domain, in units of bitplanes, by the bitplane VLD 642. Next, the bitplane shifter 644 shifts bitplanes shifted by the FGS encoding unit of FIG. 3 to the original bitplanes. The IDCT unit 646 performs IDCT on an output of the bitplane shifter 644 to restore residues in an image domain. The adder 648 combines the restored residues and respective pixels of the image output from the base-layer decoding unit 620, and reconstructs and outputs the enhancement-layer bitstream, i.e., a high-quality image.

FIG. 7 is a block diagram of an SNR scalable decoding apparatus that corresponds to the base-layer decoding unit 560 and the enhancement-layer decoding unit 580 of FIG. 5, according to an embodiment of the present invention. The apparatus of FIG. 7 includes a base-layer decoding unit 720 and an enhancement-layer decoding unit 740. The base-layer decoding unit 720 includes a VLD 722, an inverse quantizer 724, a first adder 726, an IDCT unit 728, a second adder 730, a frame memory 732, and a motion compensator 734. The enhancement-layer decoding unit 740 includes a bitplane VLD 742 and an inverse quantizer 744.

A base-layer bitstream input to the base-layer decoding unit 720 is variable-length decoded by the VLD 722. The variable-length decoded bitstream is inversely quantized by the inverse quantizer 724. Next, the IDCT unit 728 performs IDCT on a result of the inverse quantization, thereby reconstructing the base-layer bitstream as a low-quality image. If the input bitstream corresponds to a P-picture or a B-picture, the motion compensator 734 performs motion compensation on a reference frame stored in the frame memory 732. Next, the second adder 730 combines a result of motion compensation and the bitstream on which IDCT is performed so as to generate an output image. The output image is processed by a predetermined method, e.g., dithering, and displayed on a display unit (not shown).

An enhancement-layer bitstream input to the enhancement-layer decoding unit 740 is variable-length decoded by the VLD 742, inversely quantized by the inverse quantizer 744, and combined with the bit stream and the base-layer stream, which is variable-length decoded and inversely quantized, by the first adder 726. Next, the IDCT unit 728 performs IDCT on a result of the addition IDCT and outputs a result of the IDCT.

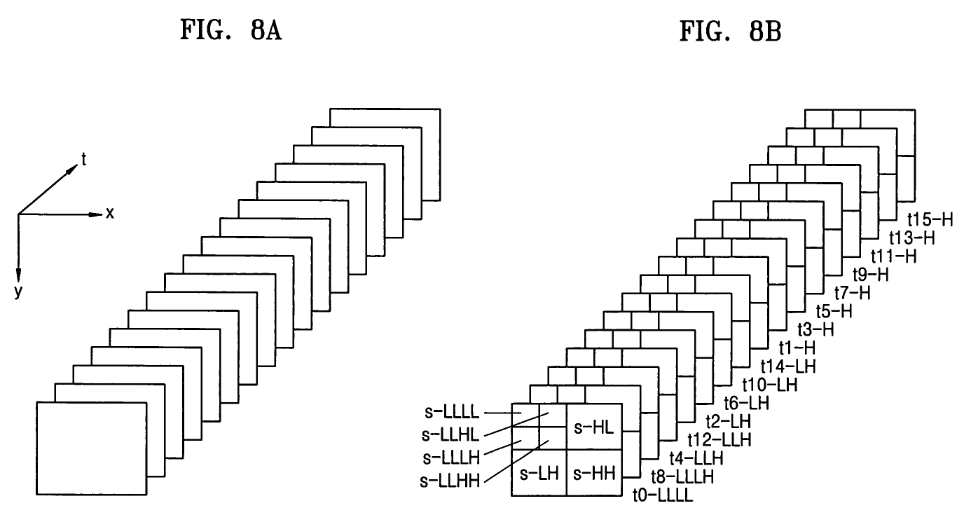

FIGS. 8A and 8B are diagrams illustrating a method of encrypting a wavelet-based scalable encoded bitstream, according to an embodiment of the present invention. In detail,

FIGS. 8A and 8B illustrate motion images that are three-dimensionally (3D) wavelet-transformed within a group-of-picture (GOP). FIG. 8A shows input images and FIG. 8B shows 3D sub-bands of the GOP.

The 3D wavelet-transformed motion pictures are compressed using a specific encoding method. In this embodiment, only bitstreams of a particular one of the 3D sub-bands are encrypted, nevertheless, it is possible to draw the same effect obtained when encrypting only enhancement-layer bitstreams using the SNR scalability encoding method. For instance, only a bitstream of one of the sub-bands of FIG. 8B, corresponding to a frame t0-LLLL, is encrypted and bitstreams of the other sub-bands are transmitted without being encrypted.

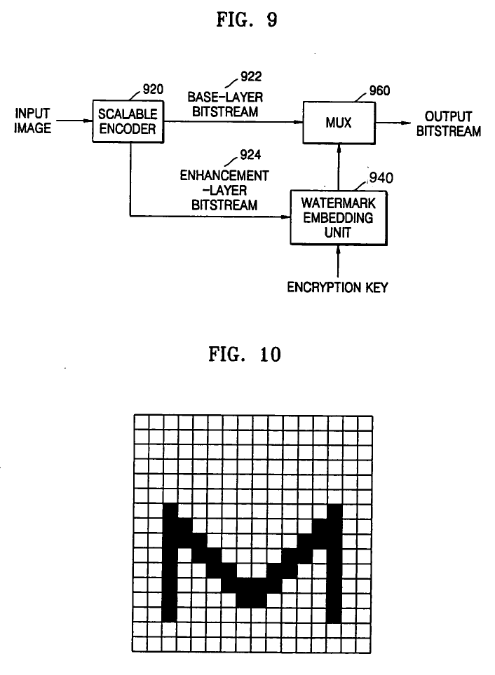

FIG. 9 is a block diagram of a scalable encoding apparatus using watermarking, according to an embodiment of the present invention. The apparatus of FIG. 9 includes a scalable encoder 920, a watermark-embedding unit 940, and a multiplexer 960.

The scalable encoder 920 generates a base-layer bitstream 922 and an enhancement-layer bitstream 924 using a predetermined scalable encoding method, and outputs the enhancement-layer bitstream 924 to the watermark-embedding unit 940.

As shown in FIG. 10, the watermark embedding unit 940 allows a watermark M, for example, to be embedded into an output high-quality image by encrypting information (i.e., watermarking information) regarding a position of the input enhancement-layer bitstream 924 into which a watermark is to be embedded, using a predetermined encryption key; and transforming a pixel value of the position into a predetermined value, e.g., 128, or performing an inverse operation on an MSB value of the pixel value.

The watermark embedding unit 940 outputs a bitstream transformed from the pixel value of the position of the input enhancement-layer bitstream into which the watermark is embedded, and a bitstream containing the encrypted watermarking information to the multiplexer 960. The encrypted watermarking information may be stored in a specific user data area of the bitstream and transmitted to the multiplexer 960.

The multiplexer 960 receives the base-layer bitstream from the scalable encoder 920, receives the enhancement-layer bitstream containing the watermark and the encrypted watermarking information from the watermark embedding unit 940, multiplexes them, and outputs a result of multiplexing.

FIG. 10 illustrates a watermark embedded into a high-quality image, according to an embodiment of the present invention.

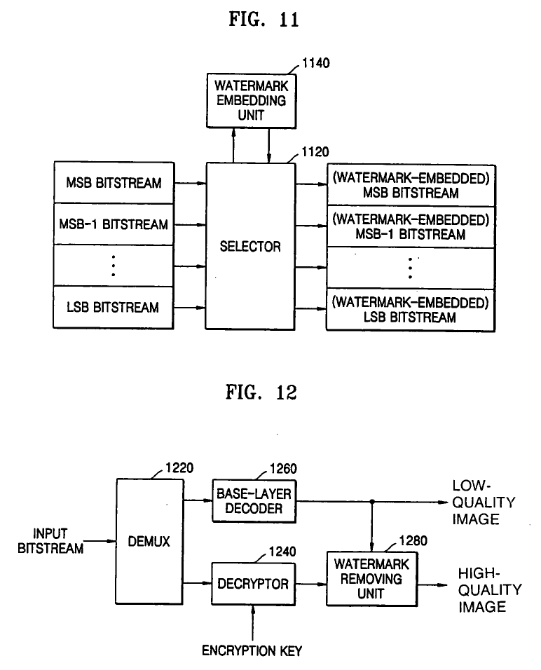

FIG. 11 is a block diagram of an apparatus for selectively embedding a watermark into a scalable encoded bitstream encoded by the FGS scalable encoding apparatus of FIG. 3, according to an embodiment of the present invention. Referring to FIG. 11, a selector 1120 selects at least one of the bitstreams, i.e., the MSB stream, the MSB-1 stream, the MSB-2 stream, . . . , the LSB stream, which are output from the enhancement-layer bitstream generating unit 340 of FIG. 3; outputs the selected bitstream to the watermark embedding unit 1140, and directly outputs the remaining bitstreams.

The watermark-embedding unit 1140, which corresponds to the watermark-embedding unit 940 of FIG. 9, embeds a watermark into the selected bitstream, and outputs the watermark-embedded bitstream to the selector 1120. Then, the selector 120 outputs the input encrypted bitstream.

Accordingly, even when an apparatus such as a decoding apparatus that receives bitstreams does not have a key for removing the watermark, at least parts of a reconstructed image can be recognized since only parts of enhancement-layer bitstreams are selectively encrypted. Thus, the apparatus of FIG. 2 allows a user to identify at least parts of the transmitted contents, and thus is applicable to various fields of application.

FIG. 12 is a block diagram of an apparatus for decoding scalable-encoded bitstreams, according to another embodiment of the present invention. The apparatus of FIG. 12 includes a demultiplexer 1220, a watermark removing module 1240, a base-layer decoder 1260, and an enhancement-layer decoder 1280.

The demultiplexer 1220 separates a base-layer bitstream and an enhancement-layer bitstream from input bitstreams, and outputs the base-layer bitstream and the enhancement-layer bitstream to the base-layer decoder 1260 and the enhancement-layer decoder 1280, respectively.

The base-layer decoder 1260 decodes the input base-layer bitstream to obtain an image. The obtained image is a low-quality image that can be independently displayed.

The watermark removing unit 1240 reconstructs watermarking information, i.e., information regarding a position of a bitstream into which a watermark is embedded, using an encryption key used to embed the watermark into the bitstream, inserts the reconstructed watermarking information into the enhancement-layer bitstream, and outputs the enhancement-layer bitstream to the enhancement-layer decoder 1280.

The enhancement-layer decoder 1280 reconstructs a high-quality image using the base-layer bitstream decoded by the base-layer decoder 1260 and the enhancement-layer bitstream encrypted by the watermark-removing unit 1240, and outputs the reconstructed high-quality image.

Embodiments of the present invention can be embodied as a computer readable code stored/transferred in a medium, e.g., a computer readable medium. Here, the computer readable medium may be any recording apparatus capable of storing/transferring data that can be read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

As described above, according to the present invention, it is possible to adaptively protect a scalable-encoded bitstream by selectively encrypting a bitstream for a particular layer or embedding a watermark into the bitstream. Therefore, the present invention is applicable to various fields of application.

While this invention has been particularly shown and described with reference to exemplary embodiments thereof, it will be understood by those skilled in the art that various changes in form and details may be made therein without departing from the spirit and scope of the invention as defined by the claims and their equivalents.

1. A method of adaptively encoding a bitstream using scalable encoding, comprising:
scalable-encoding the bitstream using a predetermined scalable encoding method and selecting at least one scalable-encoded bitstream layer; and
encrypting a bitstream corresponding to the at least one selected layer using a predetermined encryption key.

2. The method of claim 1, wherein the bitstream corresponding to the selected layer is an enhancement-layer bitstream,
the method further comprising multiplexing the encrypted enhancement-layer bitstream and a base-layer bitstream of the scalable-encoded bitstream.

3. The method of claim 2, wherein the scalable-encoding method is one of a spatial scalability encoding method, a temporal scalability encoding method, and a signal-to-noise ratio (SNR) scalable encoding method.

4. The method of claim 1, wherein the scalable-encoding method is a fine granularity scalability (FGS) encoding method, and
the bitstream corresponding to the selected layer comprises at least one bitstream of a plurality of bitstreams that are encoded in units of discrete cosine transform (DCT) planes.

5. The method of claim 1, wherein the scalable-encoding method is a wavelet-scalability encoding method, and
the bitstream corresponding to the selected layer comprises a bitstream belonging to at least one sub-band.

6. A method of adaptively encoding a bitstream using a scalable encoding method, comprising:
scalable-encoding the bitstream using a predetermined scalable encoding method and selecting at least one scalable-encoded bitstream layer; and
embedding a watermark into a bitstream corresponding to the at least one selected layer.

7. The method of claim 6, wherein the embedding of the watermark comprises:
generating watermarking information comprising a watermark position data; and
encrypting the generated watermarking information using a predetermined encryption key.

8. The method of claim 6, wherein the bitstream corresponding to the selected layer is an enhancement-layer bitstream,
the method further comprising multiplexing the enhancement-layer bitstream, into which the watermark is embedded, and a base-layer bitstream of the scalable-encoded bitstream.

9. The method of claim 8, wherein the scalable-encoding method is one of a spatial scalability encoding method, a temporal scalability encoding method, and a signal-to-noise ratio (SNR) scalable encoding method.

10. The method of claim 6, wherein the scalable-encoding method is a fine granularity scalability (FGS) encoding method, and
the bitstream corresponding to the selected layer comprises at least one bitstream of a plurality of bitstreams that are encoded in units of discrete cosine transform (DCT) planes.

11. The method of claim 6, wherein the scalable-encoding method is a wavelet-scalability encoding method, and
the bitstream corresponding to the selected layer comprises a bitstream belonging to at least one sub-band.

12. A medium comprising computer readable code implementing a method of adaptively encoding a bitstream, wherein the method comprises:
scalable-encoding the bitstream using a predetermined scalable encoding method and selecting at least one scalable-encoded bitstream layer; and
encrypting a bitstream corresponding to the at least one selected layer using a predetermined encryption key.

13. The medium of claim 12, wherein the bitstream corresponding to the selected layer is an enhancement-layer bitstream, and
the method further comprises multiplexing the encrypted enhancement-layer bitstream and a base-layer bitstream of the scalable-encoded bitstream.

14. A medium comprising computer readable code implementing a method of adaptively encoding a bitstream, wherein the method comprises:
scalable-encoding the bitstream using a predetermined scalable encoding method and selecting at least one scalable-encoded bitstream layer; and
embedding a watermark into a bitstream corresponding to the at least one selected layer using a predetermined encryption key.

15. The medium of claim 14, wherein the embedding of the watermark comprises:
generating watermarking information comprising a watermark position data; and
encrypting the generated watermarking information using a predetermined encryption key.

16. A method of decoding a scalable-encoded bitstream, comprising:
demultiplexing the scalable-encoded bitstream to extract an unencrypted bitstream and an encrypted bitstream;
decoding the extracted unencrypted bitstream;
decrypting the encrypted bitstream using a predetermined encryption key; and
reproducing an input bitstream using the decoded extracted unencrypted bitstream and the decrypted bitstream.

17. The method of claim 16, wherein the predetermined encryption key is received from a scalable-encoder and/or pre-stored in the scalable-decoder.

18. The method of claim 16, wherein the unencrypted bitstream is a base-layer bitstream and the encrypted bitstream is an enhancement-layer bitstream, and
the reproducing of the bitstreams comprises decoding the decrypted enhancement-layer bitstream using the decoded base-layer bitstream.

19. The method of claim 16, wherein the scalable-encoded bitstream is scalable-encoded using one of a spatial scalability encoding method, a temporal scalability encoding method, and a signal-to-noise ratio (SNR) scalable encoding method.

20. A method of adaptively decoding a scalable-encoded bitstream, comprising:
demultiplexing the scalable-encoded bitstream to extract a bitstream, into which a watermark is not embedded, and a bitstream into which the watermark is embedded;
decoding the bitstream into which the watermark is not embedded;
removing the watermark from the bitstream into which the watermark is embedded; and
reproducing an input bitstream using the decoded bitstream and the bitstream from which the watermark is removed.

21. The method of claim 20, wherein the removing of the watermark comprises:
decrypting watermarking information comprising a watermark position data, using a predetermined encryption key; and
replacing the embedded watermark with the watermark position data, regarding a position of the bitstream into which the watermark is embedded, by using the decrypted watermarking information.

22. The method of claim 20, wherein the bitstream into which the watermark is not embedded is a base-layer bitstream and the bitstream into which the watermark is embedded is an enhancement-layer bitstream, and
the reproducing of the input bitstream comprises decoding and reconstructing the enhancement-layer bitstream using the decoded base-layer bitstream.

23. The method of claim 20, wherein the scalable-encoded bitstream is scalable-encoded using one of a spatial scalability encoding method, a temporal scalability encoding method, and a signal-to-noise ratio (SNR) scalable encoding method.

24. A medium comprising computer readable code implementing a method of adaptively decoding a bitstream, wherein the method comprises:
demultiplexing an input scalable-encoded bitstream to extract an unencrypted bitstream and an encrypted bitstream;
decoding the extracted unencrypted bitstream;
decrypting the encrypted bitstream using a predetermined encryption key; and
reproducing the input bitstream using the decoded bitstream and the bitstream decrypted by the predetermined encryption key.

25. The recording medium of claim 23, wherein the unencrypted bitstream is a base-layer bitstream and the encrypted bitstream is an enhancement-layer bitstream, and
the reproducing of the input bitstream comprises decoding and reconstructing the enhancement-layer bitstream using the decoded base-layer bitstream.

25. A medium comprising computer readable code implementing a method of adaptively decoding a bitstream, wherein the method comprises:
demultiplexing input scalable-encoded bitstream to extract a bitstream, into which a watermark is not embedded, and a bitstream into which the watermark is embedded;
decoding the extracted bitstream into which the watermark is not embedded;
removing the watermark from the bitstream into which the watermark is embedded; and
reproducing the input bitstream using the decoded bitstream and the bitstream from which the watermark is removed.

26. The medium of claim 25, wherein the removing of the watermark comprises:
decrypting watermarking information comprising a watermark position data, using a predetermined encryption key; and
replacing the embedded watermark with the watermark position data using the decrypted watermarking information.

27. An apparatus for adaptively encoding a bitstream using scalable encoder, comprising:
a scalable-encoder encoding the bitstream using a predetermined scalable encoding method;
a selector selecting at least a scalable-encoded bitstream layer; and
an encryptor encrypting a bitstream corresponding to the selected scalable-encoded bitstream layer using a predetermined encryption key.

28. The apparatus of claim 27, wherein the bitstream corresponding to the selected scalable-encoded layer is an enhancement-layer bitstream.

29. The apparatus of claim 28, wherein the scalable-encoder is one of a spatial scalability encoder, a temporal scalability encoder, and a signal-to-noise ratio (SNR) scalable encoder.

30. The apparatus of claim 27, wherein the scalable-encoder is a fine granularity scalability (FGS) encoder, and
the bitstream corresponding to the selected scalable-encoded layer comprises at least one bitstream, of a plurality of bitstreams, encoded in units of discrete cosine transform (DCT) planes.

31. The apparatus of claim 27, wherein the scalable-encoder is a wavelet-scalability encoder, and
the bitstream corresponding to the selected scalable-encoded layer comprises a bitstream belonging to at least one sub-band.

32. A apparatus for adaptively encoding a bitstream using a scalable encoding method, comprising:
a scalable-encoder encoding the bitstream using a predetermined scalable encoding method;
a selector selecting at least one layer of the scalable-encoded bitstream; and
a watermark embedder embedding a watermark into a bitstream corresponding to the at least one selected layer.

33. The apparatus of claim 32, wherein the watermark embedder comprises:
a watermark information generator generating a watermarking information that includes data regarding a position of the bitstream into which the watermark is embedded; and
an encrypter encrypting the generated watermarking information using a predetermined encryption key.

34. The apparatus of claim 32, the apparatus further comprises:
a multiplexer to multiplex the enhancement-layer bitstream, into which the watermark is embedded, and a base-layer bitstream of the scalable-encoded bitstream.

35. The apparatus of claim 33, wherein the scalable-encoder is one of a spatial scalability encoder, a temporal scalability encoder, and a signal-to-noise ratio (SNR) scalable encoder.

36. The apparatus of claim 32, wherein the scalable-encoder is a fine granularity scalability (FGS) encoder, and
the bitstream corresponding to the selected layer comprises at least one bitstream of a plurality of bitstreams that are encoded in units of discrete cosine transform (DCT) planes.

37. The apparatus of claim 32, wherein the scalable-encoder is a wavelet-scalability encoder, and
the bitstream corresponding to the selected layer comprises a bitstream belonging to at least one sub-band.

38. A scalable-encoded bitstream decoder, comprising:
a demultiplexer demultiplexing the scalable-encoded bitstream into an unencrypted bitstream and an encrypted bitstream;
a decoder to decode the unencrypted bitstream;
a decryptor to decrypt the encrypted bitstream using a predetermined encryption key.

39. The apparatus of claim 38, further comprising:
a reproducing unit to reconstruct the scalable-encoded bitstream into an original bitstream using the decoded bitstream and the decrypted bitstream.

40. The apparatus of claim 38, wherein the unencrypted bitstream is a base-layer bitstream and the encrypted bitstream is an enhancement-layer bitstream.

41. The apparatus of claim 38, wherein the scalable-encoded bitstream encoder is a scalable-encoder using one of a spatial scalability encoder, a temporal scalability encoder, and a signal-to-noise ratio (SNR) scalable encoder.

42. An adaptive decoder adaptively decoding a scalable-encoded bitstream, comprising:
a demultiplexer to demultiplex the scalable-encoded bitstream to extract into a bitstream, in which a watermark is not embedded, and a bitstream in which the watermark is embedded;
a decoder to decode the bitstream in which the watermark is not embedded;
a watermark removing unit to remove the watermark from the bitstream in which the watermark is embedded; and
a reproducing unit to reproduce an input bitstream using the decoded bitstream and the bitstream in which the watermark is removed.

43. The decoder of claim 42, wherein the watermark removing unit comprises:
a watermarking information decryptor to decrypt the bitstream in which the watermark is embedded, including data regarding a position of the embedded watermark, using a predetermined encryption key; and
replacing the embedded watermark with the data regarding the position of the embedded watermark by using the decrypted watermarking information.

44. The apparatus of claim 43, wherein the bitstream into which the watermark is not embedded is a base-layer bitstream and the bitstream into which the watermark is embedded is an enhancement-layer bitstream, and
the reproducing of the input bitstream comprises decoding a reconstruction of the enhancement-layer bitstream using the decoded base-layer bitstream.

45. The apparatus of claim 43, wherein the bitstream scalable-encoder is a scalable-encoder using one of a spatial scalability encoder, a temporal scalability encoder, and a signal-to-noise ratio (SNR) scalable encoder.

46. A method of adaptively encoding a bitstream using scalable encoding, comprising:
scalable-encoding the bitstream using a predetermined scalable encoding method;
encrypting a first bitstream layer of the bitstream with a first predetermined encryption key; and
embedding a watermark into a second bitstream layer of the bitstream.

47. The method of claim 46, wherein the first bitstream layer is an enhancement-layer bitstream,

48. The method of claim 46, wherein the second bitstream layer is an enhancement-layer bitstream.

49. The method of claim 46, the method further comprising:
Multiplexing the encrypted first bitstream layer, the watermarked second bitstream layer, a third bit stream layer of the scalable-encoded bitstream.
